(19) United States
(12) Patent Application Publication
(10) Pub. No.: US 2008/0259480 A1
(43) Pub. Date: Oct. 23, 2008

(54) Glide test and calibration using flying height on demand

(75) Inventors: Hoa Pham, San Jose, CA (US); Vinod Sharma, Los Gatos, CA (US); Sang Lee, Ladera Ranch, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/787,879

(22) Filed: Apr. 17, 2007

(51) Int. Cl. G11B 5/455; G11B 15/64; G11B 5/56

(52) U.S. Cl. 360/25; 360/294.7; 360/128; 73/104

(57) ABSTRACT

A glide head that can be used to certify disks of hard disk drives. The glide head includes a heater that can change the temperature of a slider surface of the head and vary the head flying height. The slider surface may induce the negative pressure so that the glide head more accurately simulates a head used in a production disk drive. A piezoelectric transducer may be coupled to the glide head so that contact between the head and a disk may be sensed and recorded in a disk certification routine.

### BACKGROUND OF THE INVENTION

1. Field of the Invention

The present invention relates to a glide test head used to certify a disk of a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

In operation, each head is separated from a corresponding disk surface by an air bearing. The air bearing minimizes the mechanical wear between the head and the disk. The strength of the magnetic field is inversely proportional to the height of the air bearing. A smaller air bearing results in a stronger magnetic field on the disks, and vice versa.

The heads typically fly very close to the disk. Any protrusions or other surface irregularities in the disk surfaces may create contact between the heads and the disks. Such contact may cause mechanical wear between the components. Additionally, contact between the heads and disk surfaces may create particles or other by-products that may contaminate the drive.

When mass producing disk drives, the disks are tested to insure a desired surface finish and to determine the magnetic characteristics of each disk. Disks that do not meet certain standards are either re-worked or discarded. Disks are typically tested in a system commonly referred to as a disk certifier. Disk certifiers contain glide heads that can be used to test disks that are loaded onto a spindle motor of the certifier. The certifier also contains electronic circuits that can be used to perform tests. The glide head is usually coupled to a contact sensor, such as a piezoelectric transducer, used to count the number of times the glide head makes contact with the disk surface.

It is desirable to vary the flying height of the glide head during testing to obtain data on the surface of the disk. The flying height is typically varied by using a glide head with a positive pressure slider surface and changing the speed of the spindle motor. Most commercially available disk drives utilize heads that have a negative pressure slider surface. Using a positive pressure slider surface during testing may give results different from those seen in actual disk drives using negative slider surfaces. Negative pressure glide heads are not used to certify disks because such heads do not exhibit as much variation in flying height with changes in spindle motor speed. It would be desirable to provide a disk certifier that can vary fly height with a negative pressure glide head.

### BRIEF SUMMARY OF THE INVENTION

A glide head that is used to certify a disk of a hard disk drive. The glide head includes a heating element that can heat and vary a flying height of the head.

### BRIEF DESCRIPTION OF THE DRAWINGS

FIG. 1 is a top view of an embodiment of a hard disk drive;

FIG. 2 is a top enlarged view of a head of the hard disk drive;

FIG. 3 is a schematic of a disk certifier for testing disks of hard disk drives;

FIG. 4 is a bottom perspective view of a glide head;

FIG. 5 is a graph showing a glide test of a disk.

### DETAILED DESCRIPTION

Disclosed is a glide head that can be used to certify disks of hard disk drives. The glide head includes a heating element that can change the temperature of a slider surface of the head in the vicinity of the read/write transducers and vary the head flying height. The slider surface may induce a negative pressure so that the glide head more accurately simulates a head used in a production disk drive. A piezoelectric transducer may be coupled to the glide head so that contact between the head and a disk may be sensed and recorded in a disk certification routine.

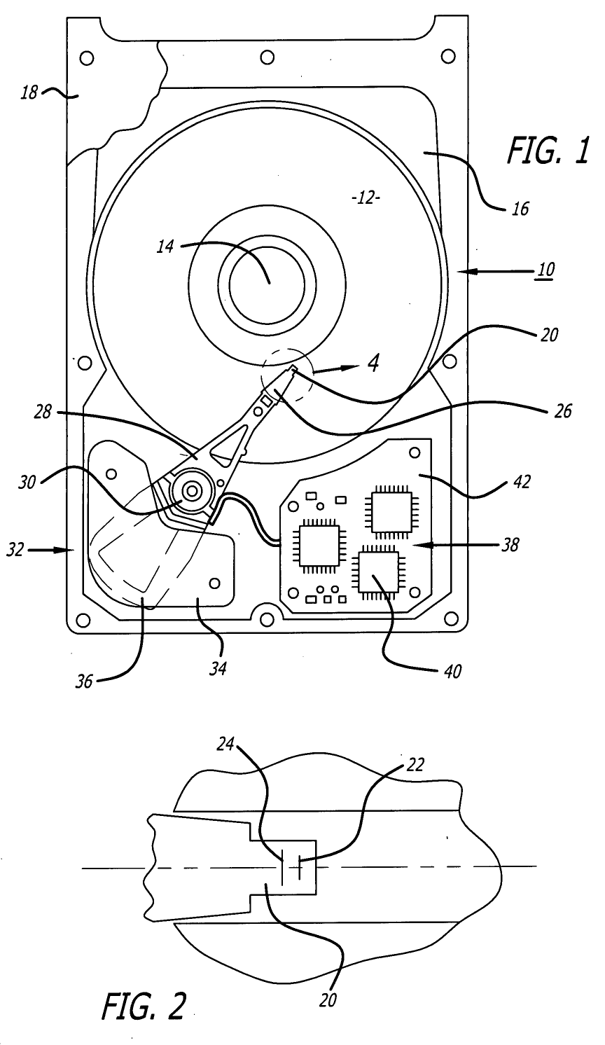

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. As shown in FIG. 2 the heads 20 may have separate write 22 and read elements 24. The write element 22 magnetizes the disk 12 to write data. The read element 24 senses the magnetic fields of the disks 12 to read data. By way of example, the read element 24 may be constructed from a magneto-resistive material that has a resistance which varies linearly with changes in magnetic flux.

Referring to FIG. 1, each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

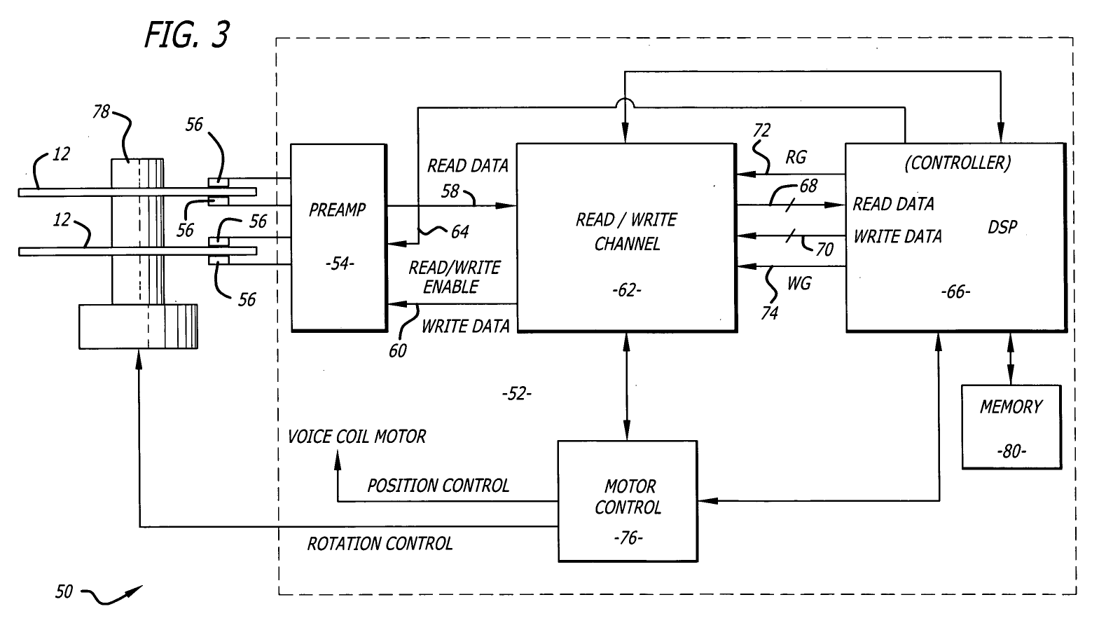

FIG. 3 shows an embodiment of a disk certifier 50 that can be used to test and certify whether one or more disks comply with certain factory specifications. The certifier 50 may include various electrical circuits 52 for reading and writing data onto the disks 12. The circuits may include a pre-amplifier circuit 54 that is coupled to a plurality of glide heads 56. There may be a glide head 56 for each disk surface. The pre-amplifier circuit 54 has a read data channel 58 and a write data channel 60 that are connected to a read/write channel circuit 62. The pre-amplifier 54 also has a read/write enable gate 64 connected to a controller 66. Data can be written onto the disks 12, or read from the disks 12 by enabling the read/write enable gate 64.

The read/write channel circuit 62 is connected to the controller 66 through read and write channels 68 and 70, respectively, and read and write gates 72 and 74, respectively. The read gate 72 is enabled when data is to be read from the disks 12. The write gate 74 is to be enabled when writing data to the disks 12. The controller 66 may be a digital signal processor that operates in accordance with a software routine, including a routine(s) to write and read data from the disks 12. The read/write channel circuit 62 and controller 66 may also be connected to a motor control circuit 76 that controls a voice coil motor (not shown) and a spindle motor 78 of the certifier 10. The voice coil motor can move the glide heads 56 relative to the disks 12. The controller 66 may be connected to a non-volatile memory device 80. By way of example, the device 80 may be a read only memory (“ROM”) that contains instructions that are read by the controller 66. The disks 12 can be loaded and unloaded from the spindle motor 78 so that disks can be continuously tested 10, by the certifier 50.

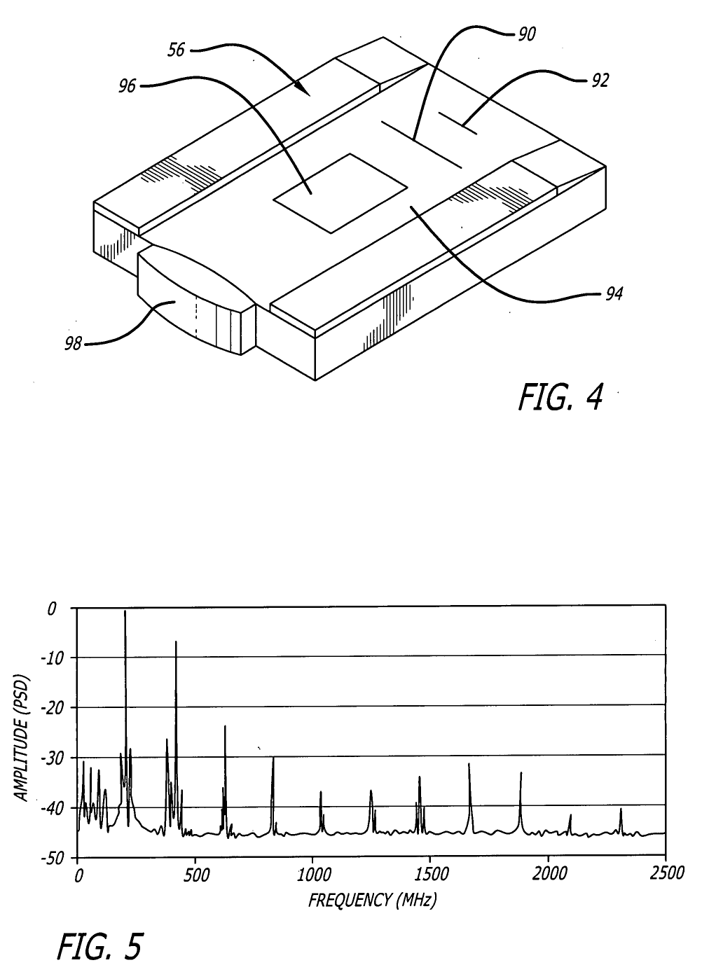

As shown in FIG. 4 each glide head 56 may include a read element 90, a write element 92 and a slider surface 94. The read element 90 is used to read a signal(s) from the disk. The write element 92 is used to write a signal(s) onto the disk. The slider surface 94 is preferably constructed to create an air bearing between the head 56 and disk with a negative pressure. The height of the air bearing is commonly referred to as the flying height of the head.

The glide head 56 has a heating element 96. The heating element 96 is preferably located on the slider surface 94 in the vicinity of read and write elements. The heating element 96 may be a resistive element that is connected to the preamp and controlled by the controller of the disk certifier.

The heating element 96 can generate heat that thermally expands the slider surface 94. The expansion of the slider surface 94 varies the flying height of the head. The controller of the disk certifier can change the current supplied to the heating element 96, which varies the heat and the flying height of the glide head 56. Thus the disk certifier is capable of varying the flying height of a negative pressure slider without changing the speed of the spindle motor.

The glider heads 56 may each have a contact sensor 98 that can sense contact between the heads and the disk surfaces. The contact sensor 98 may include a piezoelectric transducer that provides an electrical output signal that varies with mechanical strain as is known in the art. The signal may be provided to the controller of the certifier 50.

The disk certifier 50 may operate a disk certification routine wherein the glide heads 56 are “flown” adjacent to the disk surfaces. Contact between the heads and disk surfaces can be detected and recorded by the certifier. FIG. 5 is an example of a test run on a disk. The spikes are indicative of head contact. The flying heights of the glide heads can be varied by changing the current provided to the heating elements. Data can be recorded at different flying heights.

Disk certification may also include writing a signal onto the disk thru the write elements of the glide heads. The signal may be a simple sinusoidal signal. The signal can be read through the read elements of the glide heads. The read signals can be analyzed by the certifier to determine whether the disk meets certain criteria. The flying heights of the glide heads may also be varied during this part of the certification process.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A glide head used to test a disk of a hard disk drive, comprising:
a head that has a slider surface, a read element, a write element, and a heating element; and,
a contact sensor coupled to said head.

2. The glide head of claim 1, wherein said slider surface induces a negative pressure.

3. The glide head of claim 2, wherein said contact sensor includes a piezoelectric transducer.

4. A certification system for testing a disk of a hard disk drive, comprising:
a spindle motor that can rotate the disk;
a glide head coupled to said disk, said glide head has a slider surface, a read element, a write element, and a heating element;
a contact sensor coupled to said glide head; and,
a controller coupled to said glide head, said controller performs at least one test to certify the disk.

5. The system of claim 4, wherein said slider surface induces a negative pressure between said glide head and the disk.

6. The system of claim 4, wherein said contact sensor includes a piezoelectric transducer.

7. The system of claim 4, wherein said controller analyzes and stores a number of times said glide head makes contact with the disk.

8. The system of claim 4, wherein said controller reads a signal from the disk to certify the disk.

9. The system of claim 4, wherein said controller controls said heating element to vary a flying height of said glide head.

10. A method for certifying a disk of a hard disk drive, comprising:
coupling a disk to a spindle motor;
rotating the disk;
flying a glide head adjacent to the disk;
performing a certifying test of the disk; and, heating the glide head to vary a flying height of the glide head during the certifying test.

11. The method of claim 10, further comprising counting a number of times the glide head makes contact with the disk.

12. The method of claim 11, further comprising reading a signal from the disk thru the glide head.

13. The method of claim 10, wherein the glide head induces a negative pressure between the glide head and the disk.
